(19) United States
(12) Patent Application Publication
(10) Pub. No.: US 2004/0153359 A1
(43) Pub. Date: Aug. 5, 2004

(54) Integrated supply chain management

(76) Inventors: Mein-Kai Ho, Mendota Heights, MN (US); Joseph J. Gaffney, Woodbury, MN (US); Paul C. Husby, Minneapolis, MN (US); Richard J. Marchant, Woodbury, MN (US); Mary V. Nowlin, Hudson, WI (US); Leann C. Tolk, Hudson, WI (US); Harish Vedavyasa, Cottage Grove, MN (US)

Correspondence Address: 3M INNOVATIVE PROPERTIES COMPANY, PO BOX 33427, ST. PAUL, MN, 55133-3427, US

(21) Appl. No.: 10/357,269

(22) Filed: Jan. 31, 2003

(51) Int. Cl. G06F 17/60

(52) U.S. Cl. 705/10

(57) ABSTRACT

A centralized supply chain management system is described that comprises a connectivity module that electronically communicates with enterprise data systems within one or more supply chains. The connectivity module receives part definitions and shipment data from the various data systems. A data alignment module generates a mapping between the part definitions of the various enterprises, and translates electronic data received from the enterprises in accordance with the mapping. A vendor managed inventory (VMI) module generates electronic orders based on the shipment data to provide automated control over inventor levels within the supply chain. A market analysis module generates market penetration models for the enterprises.

### TECHNICAL FIELD

The invention generally relates to techniques for coordinating and managing a supply chain.

### BACKGROUND

A supply chain is a complex association of people and organizations that interact to produce and sell a product or a service. A typical supply chain involves a number of suppliers, manufacturers, wholesalers, distributors and stores that enable a product to be manufactured, sold and delivered to consumers (e.g., customers or other end users). Supply chains exist in both service and manufacturing industries.

Supply chain management refers to the practice of managing the flow of products or services from the suppliers along the supply chain to the consumers. For example, supply chain management may involve or affect all stages of the supply chain, including sourcing raw materials and parts, manufacturing and assembly, warehousing and inventory tracking, order entry and order management, product distribution, and delivery to the customer. In general, supply chain management seeks to increase revenues (e.g., by reducing time to market or otherwise improving product availability) and reduce costs (e.g., by reducing inventory and improving procurement efficiencies). For example, manufacturers may wish to manage the supply chain so as to react quickly to market preferences, product changes, shortages of raw materials, accidents, natural disasters or other occurrences.

Due to its wide scope, supply chain management must address complex interdependencies, in effect creating an “extended enterprise” that reaches far beyond the factory door. Today, material and service suppliers, channel supply partners (wholesalers/distributors, retailers), and customers themselves, as well as supply-chain management consultants, software product suppliers and system developers, are all key players in supply chain management.

A variety of systems have been developed and employed by enterprises in an attempt to coordinate activities within a supply chain. For example, Supply Chain Planning (SCP) software uses scheduling algorithms to improve the flow of products through the supply chain, thereby increasing efficiency and reducing inventory of the supply chain. Supply Chain Execution (SCE) software is designed to automate the flow of the supply chain. For example, Manufacturing Resource Planning (“MRP”) and Enterprise Resource Planning (“ERP”) tools have been employed by enterprises in an effort to automate or otherwise improve the flow of products through the supply chain.

The various enterprises and organizations of a supply chain often employ disparate systems from many different software vendors, each providing a portion of the capabilities of the overall supply chain. Often, these systems are incompatible. Moreover, enterprises at each stage of the supply chain may have complex product lines that comprise hundreds or thousands of products with each product requiring thousands of material components. As a result, automated flow of information through the supply chain is restricted, and comprehensive management of a supply chain can be difficult to achieve.

### SUMMARY

In general, the invention is directed to techniques for integration and management of enterprises associated with one or more supply chains. For example, the techniques provide a system for centralized control over the enterprises. The supply chain management system provides interfaces and business logic for seamless interaction with data systems maintained by suppliers, distributors and customers associated with the supply chains. In this manner, the supply chain management system provides a centralized system for the automated electronic communication and integration of the disparate data systems of the enterprises. Supply chain management system provides control and management over the flow of information between the entities associated with a supply chain and, as described in detail below, handles the translation of part definitions, service definitions, or combinations thereof, for integration of the data systems of the supply chain enterprises.

The supply chain management system provides an intelligent centralized system for automatically mapping and translating between these otherwise incompatible definitions to ease integration and automate communication between the enterprise data systems of the supply chain. Consequently, the supply chain management system provides for the automatic translation and alignment of data communicated between the data systems, and provides an integrated environment for comprehensive management of the supply chain.

The supply chain management system uses the aligned data as the basis for a variety of operations. For example, the aligned data captured from all stages of the supply chain can be used for automated vendor managed inventory (VMI), electronic invoice presentation and payment (EIPP), market analysis, and the like. By making use of aligned data, the supply chain management system may more accurately identify trends, predict demand for inventory, and automatically adjust inventory levels. Embodiments of the supply chain management system can easily issue reports, purchase orders, invoices, marketing models, and the like, in enterprise-specific formats that can be easily processed and reviewed by the various enterprises within the supply chain.

In one embodiment, the system includes a connectivity module that electronically communicates with enterprise data systems within the supply chains. The connectivity module receives part definitions and shipment data from the various data systems. A data alignment module generates a mapping between the part definitions of the various enterprises, and translates electronic data received from the enterprises in accordance with the mapping. A vendor managed inventory (VMI) module generates electronic orders based on the shipment data to provide automated control over inventor levels within the supply chain. A market analysis module generates market penetration models for the enterprises.

In another embodiment, the invention is directed to a system comprising a connectivity module that electronically communicates with a distributor data system and a supplier data system. The connectivity module receives from the distributor data system part shipment data for parts shipped from the distributor to customers. The system further comprises a vendor managed inventory (VMI) module that generates electronic orders for the distributor to purchase additional parts from the supplier based on the part shipment data, and a market analysis module that generates a market penetration model for the supplier on the part shipment data received from the distributor data system.

In another embodiment, the invention is directed to a method comprising generating a mapping between distributor part definitions maintained by a distributor data system and supplier part definitions maintained by a supplier data system, and receiving part shipment data from the distributor data system that indicates parts shipped from a distributor to customers, wherein the part shipment data conforms to the set of distributor part definitions. The method further comprises generating a market penetration model in a format that conforms to the supplier part definitions based on the mapping.

These and other embodiments, including other systems, methods and computer-readable mediums that store instructions and data, are described in the specification and claims below. The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a system for centrally managing one or more supply chains.

FIG. 2 is a block diagram illustrating an example embodiment of a supply chain management system.

FIG. 3 is a block diagram that illustrates exemplary data communication between the supply chain management system and an example remote data system.

FIG. 4 is a block diagram illustrating exemplary data flow through the supply chain management system and, in particular, data flow from a communication module to a set of application software modules.

FIG. 5 is a flow chart illustrating exemplary operation of the supply chain management system that provides integrated management and control of the stages of a supply chain.

FIG. 6 is a block diagram that generally illustrates the flow of electronic communication between a supply chain management system and external enterprises within the supply chain.

FIG. 7 is a flowchart illustrating exemplary operation of a connectivity module.

FIG. 8 is a flowchart illustrating exemplary operation of a data alignment module.

FIG. 9 is a flowchart illustrating exemplary operation of a Vendor Managed Inventory (VMI) module.

FIG. 10 is a flowchart illustrating exemplary operation of an Electronic Presentation and Payment (EIPP) module.

FIG. 11 is a flowchart illustrating exemplary operation of a market analysis module.

FIGS. 12-13 illustrate an exemplary web-based user interface presented by a connectivity module.

FIG. 14 illustrates an exemplary purchase order confirmation provided by a connectivity module upon receiving purchase orders from an enterprise.

FIG. 15 illustrates an exemplary purchase order change detail that lists modifications to the purchase order based on the product definitions provided by the supplier.

FIG. 16 illustrates an exemplary advance ship notice generated by a connectivity module and communicated to the purchaser upon receiving shipment data from the supplier.

FIGS. 17-20 illustrate an exemplary interface provided by a VMI module.

FIG. 21 illustrates an exemplary reconciliation report produced by a data alignment module to identify potential inconsistencies between part definitions of a part and a consumer of a part (e.g., a supplier and a distributor or a distributor and a customer).

FIGS. 22-30 illustrate exemplary interfaces and reports presented by the EIPP module.

### DETAILED DESCRIPTION

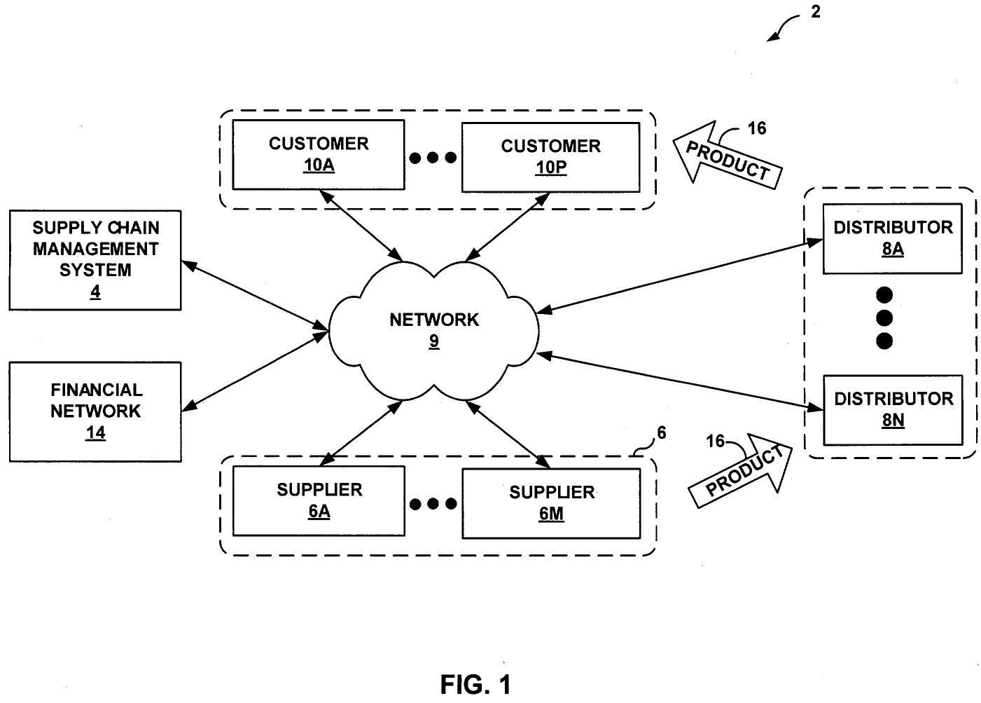

FIG. 1 is a block diagram illustrating an exemplary system 2 for centrally managing one or more supply chains. More specifically, system 2 includes a supply chain management system 4 for managing supply chains formed by associations of suppliers 6A-6M (“suppliers 6”), distributors 8A-8N (“distributors 8”), and customers 10A-10P (“customers 10”). In general, each of suppliers 6 represents a supplier of any raw material, component, element, ingredient, device, or the like, that is eventually integrated into one or more products 16 sold to customers 10 via distributors 8. A single supply chain may, therefore, involve multiple levels of suppliers 6, distributors 8, or both. Suppliers 6A and 6B, for example, may provide raw material, parts, or the like, to supplier 6C, which may in turn manufacture and provide products 16 to one or more channels of distributors 8 for sale to customers 10.

Supply chain management system 4, as described in detail herein, provides network-based integration and control over the various enterprises associated with the supply chains. More specifically, authorized users of suppliers 6, distributors 8, and customer 10 interact with supply chain management system 4 via network 9 to control the stages of the supply chain. Examples of authorized users that may make use of the integrated environment provided by supply chain management system 4 include purchasing agents, accounts payable, sales and marketing managers, customer service representatives, supply chain specialists, credit professionals, channel and business development managers, sales representatives, and the like. Although described for exemplary purposes in reference to supply chains for production and sale of products, the techniques described herein may be applied to management of supply chains for the sale of products, services, or combinations thereof. Suppliers 6 may, for example, supply services, such as labor, scheduling, installation, and the like, either separately or in combination with products 16. Moreover, these services can be viewed as intangible products that may be managed using the techniques described herein.

By interacting with supply chain management system 4, as described below, remote users can perform a variety of tasks related to supply chain management, including electronic order generation for product 16 from suppliers 6 and distributors 8, electronic generation and processing of invoices for the orders, automated management of inventory levels within the supply chain, automated tracking of product 16 shipped through the supply chain, and other tasks.

Each user typically accesses supply chain management system 4 via network 9 using a remote computing device having suitable communication software (e.g., a web browser). A user may access supply chain management system 4 using a network-enabled computing device, such as a workstation, personal computer, laptop computer, or a personal digital assistant (PDA) (such as an organizer marketed by Palm, Inc. of Santa Clara, Calif., under the trade designation “PALM”). The communication device executes communication software (such as software marketed by Microsoft Corporation of Redmond, Wash., under the trade designation “INTERNET EXPLORER”) in order to communicate with supply chain management system 4.

In addition, supply chain management system 4 provides interfaces and business logic for seamless interaction with internal data systems maintained by suppliers 6, distributors 8 and customers 10. In other words, supply chain management system 4 provides a centralized system for the automated electronic communication between, and integration of, the disparate data systems of suppliers 6, distributors 8 and customers 10. Supply chain management system 4 provides centralized control and management over the flow of information between the entities associated with a supply chain and, as described in detail below, handles the translation necessary for integration of the data systems of the supply chain enterprises. Network 9 represents any communication mechanism suitable for communicating data, such as a wide-area network, local area network, or a global computer network like the World Wide Web.

To facilitate the integration of the various data systems, supply chain management system 4 maintains a comprehensive mapping between “part definitions” for each of suppliers 6, distributors 8, and customers 10 along the supply chain. As used herein, the term part definition refers to data that describes a specific item used within the supply chain (e.g., a product, raw material, part, component, ingredient or other item). Inherently, each enterprise within the supply chain maintains complex categorization and definition of each item that it consumes or produces, and these definitions may not be identical to definitions provided by other enterprises. For example, a manufacturer may assign a particular component used during manufacturing (e.g., a particular type of electronic component) with a unique part number, and may order the component from one or more suppliers. These suppliers may maintain different part numbers for the component, and quite often vary in terms of price, part availability, and the like.

For example, for each consumed part, an enterprise within the supply chain may maintain a definition that includes a supplier part number, a unit of measure (UOM), a price per UOM, a price multiplier, a rounding value, and a lead-time for receiving the part from the supplier. For each produced part, the enterprise may maintain a definition that includes a part number, a unit of measure (UOM), a discount code, a discount amount, a case quantity, a price, a part type, and a lead time for shipping the part.

Supply chain management system 4 provides an intelligent centralized system for automatically mapping and translating between these otherwise incompatible definitions to ease integration and automate communication between the enterprise data systems of the supply chain. Consequently, supply chain management system 4 provides for the automatic alignment of data communicated between the data systems of suppliers 6, distributors 8 and customers 10 to provide an integrated environment for comprehensive management of the supply chain.

This aligned data forms the basis for a variety of operations. For example, the aligned data from all stages of the supply chain can be used for automated vendor managed inventory (VMI). In general, VMI refers to the ability of suppliers to predict demand for their parts, and automatically control inventory levels of distributors 8 and customers 10 in response.

By making use of aligned data, supply chain management system 4 may provide VMI functionality that utilizes data from all stages of the supply-chain, and more accurately identifies trends, predicts demand for inventory, and automatically adjusts inventory levels. Based on the predicted demand, supply chain management system 4 may generate electronic orders for the purchase of additional inventory at various stages of the supply chain, and can be used to control electronic payment of the invoices by the receiving enterprises. Similarly, VMI functionality may be used to automatically generate orders for services or products in combination with services. Supply chain management system 4 utilizes the aligned data to generate the invoices and effect the electronic transactions in a format consistent with the disparate data systems.

In addition, supply chain management system 4 may utilize the aligned data captured throughout the supply chain as the basis for comprehensive market models and reports. For example, supply chain management system 4 may use the aligned data to generate a market penetration report that traces part flows from suppliers 6 through distributors 8 to customers 10. Supply chain management system 4 may generate the report to identify sales volumes and accounts at each stage of the supply chain. Moreover, supply chain management system 4 may generate the report for a particular enterprise within the supply chain (e.g., a particular supplier 6) and in a format consistent with the part definitions of the enterprise.

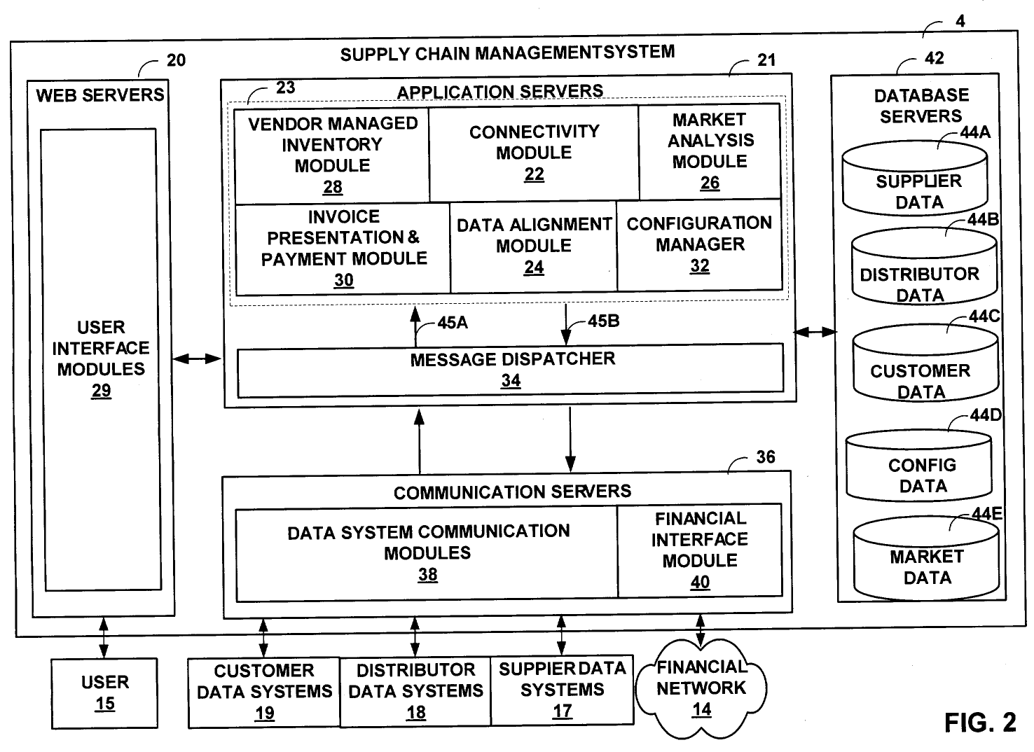

FIG. 2 is a block diagram illustrating supply chain management system 4 in further detail. In general, supply chain management system 4 includes one or more computing devices (e.g., computing servers that provide operating environments for various software modules). These servers can generally be categorized as web servers 20, application servers 21, communication servers 36, and database servers 42. Although these servers are illustrated separately in FIG. 2, supply chain management system 4 may be realized by a single computing device, or a plurality of cooperating computing devices.

Web servers 20 provide an interface by which authorized users 15 communicate with supply chain management system 4 via network 9. In one configuration, web servers 20 execute web server software (such as software marketed by Microsoft Corporation under the trade designation “INTERNET INFORMATION SERVER”). As such, web servers 20 provide an environment for interacting with remote users 15 according to user interface modules 29, which can include Active Server Pages, web pages written in hypertext markup language (HTML) or dynamic HTML, Active X modules, Lotus scripts, Java scripts, Java Applets, Distributed Component Object Modules (DCOM) and the like.

Although illustrated as “server side” software modules executing within an operating environment provided by web server 20, user interface modules 29 could readily be implemented as “client-side” software modules executing on computing devices of the remote users. User interface modules 29 could, for example, be implemented as Active X modules executed by a web browser for execution on the remote computing devices.

Communication servers 36 provide an operating environment for data system communication modules that provide the ability to establish direct connections with the disparate data systems of the enterprises within the supply chain (e.g., supplier data systems 17, distributor data systems 18, and customer data systems 19). In this manner, supply chain management system 4 can automatically interact with data systems 17, 18, 19. Financial interface module 40 manages electronic communication between supply chain management system 4 and financial network 14.

Application servers 21 provide an operating environment for application software modules 23, which provide the underlying business logic and functionality necessary for integration and interaction with the various enterprises of the supply chain. Message dispatcher 34 receives communications from data system communication module 38 and financial interface module 40, and issues inbound messages 45A to application software modules 23 to process the communications. In particular, data systems communication module 38 and financial interface 40 may receive electronic communications from data systems 17, 18, 19, and, in turn, forward the communications to message dispatcher 34. Message dispatcher 34 determines the appropriate application software modules 23 for processing the communication, and dispatches one or more inbound message 45A to the identified modules. In a similar manner, application software modules 23 may generate outbound messages 45B to communicate with external data systems 17, 18, 19.

Application software modules 23 may include a number of modules including connectivity module 22, data alignment module 24, market analysis module 26, vendor managed inventory (VMI) module 28, electronic invoice presentation and payment (EIPP) module 30 and configuration manager 32. Application software modules 23 interact with database servers 42 to access a number of data stores 44, including supplier data 44A, distributor data 44B, customer data 44C, configuration (CONFIG) data 44D and market data 44E. Data stores 44 may be implemented in a number of different forms including data storage files, or as a database management system (DBMS). The database management system may be a relational (RDBMS), hierarchical (HDBMS), multidimensional (MDBMS), object oriented (ODBMS or OODBMS) or object relational (ORDBMS), or other database management system. Furthermore, although illustrated separately, data stores 44 could be combined into a single database or other data storage structure. Data stores 44 could, for example, be implemented as a single relational database (such as that marketed by Microsoft Corporation under the trade designation “SQL SERVER”).

In general, connectivity module 22 is responsible for handling the majority of the electronic communication with data systems 17, 18, 19. For example, connectivity module 22 electronically receives supplier part definitions from the supplier data systems 17, the distributor part definitions from the distributor data systems 18 and customer part definitions from customer data systems 19, and stores the part definitions within data stores 44A, 44B, and 44C, respectively. In addition, connectivity module 22 receives part shipment data from distributor data systems 18 that describe parts shipped from distributors 8 to customers 10. Connectivity module 22 may receive the part definitions and part shipment data periodically (e.g., nightly, or asynchronously) when parts are shipped or the definitions changed.

Data alignment module 24 processes the data received by connectivity module, and adaptively generates and maintains a mapping between the part definitions maintained by the enterprises within the supply chain. In other words, data alignment module 24 provides for the automated translation between these otherwise incompatible definitions to ease integration and automate communication between data systems 17, 18, 19 of the supply chain. During this process, data alignment module 24 may issue electronic reports to suppliers 6, distributors 8, and customers 10 indicating any discrepancies between the various part definitions. Moreover, data alignment module 24 dynamically updates the mapping based on the part definition data continuously received (e.g., nightly or weekly) via connectivity module 22.

The aligned data produced by data alignment module 24 forms the basis for a variety of operations performed by market analysis module 26, VMI module 28, and EIPP module 30. In general, VMI module 28 provides functionality to predict demand for parts within the supply chain, and automate the control of inventory levels within the supply chain. For example, VMI module 28 may analyze the part shipment data received from connectivity module 22 and processed by data alignment module 24 to generate forecast data indicating predicted demand values for the parts at various stages of the supply chain.

Moreover, VMI module 28 may generate electronic orders based on the forecast data for purchasing additional parts from the respective suppliers 6 or distributors 8. VMI module 28 may utilize the aligned data and the part definition mapping to generate the electronic orders in a format consistent with the part definitions of the respective suppliers. VMI module 28 may communicate the electronic orders to the appropriate supplier data systems 17 to automatically purchase the additional parts from the supplier for the distributor, or may present the electronic orders via user interface modules 29 and web servers 20 for approval by the appropriate users.

EIPP module 30 may handle all aspects of invoice handling, including generation of electronic invoices for payment by the listed payors (e.g., distributors 8 or customers 10) purchasing products from suppliers 6, possibly in response to the electronic orders generated by VMI module 28. EIPP module 30 makes use of the aligned data and mapping scheme maintained by supply chain management system 4 to generate each of the electronic invoices in a format consistent with the part definitions received from the payor, thereby allowing the data system of the payor to easily receive and process electronic invoices. EIPP module 30 may communicate the electronic invoices to the data system of the payors, or may present the electronic invoices via user interface modules 29 and web servers 20 for approval by authorized users 15 associated with the payors.

Upon receiving an approval (e.g., via web servers 20 or directly from the data system of the payor) EIPP module 30 initiates electronic fund transfers (EFT) from a bank account of the payor to a bank account of the payee for payment of the electronic invoices. For example, EIPP module 30 may initiate an EFT to transfer funds directly from an account of a customer 10 to an account of a distributor 8, from an account of a distributor to an account of a supplier 6, or even from an account of one supplier to another.

EIPP module 30 provides an interface by which to receive dispute data that indicates the payor disputes one or more of the invoices. EIPP module 30 is responsible for informing the payee of the dispute, e.g., by direct electronic communication with the data system of the payee or by presents the dispute data via user interface modules 29. EIPP module 30 may utilize the aligned data and the mapping scheme to present the dispute data in a format consistent with the part definitions of the payee, thereby allowing the payee of the receiving data system to easily process and resolve the dispute.

Market analysis module 26 utilizes the aligned data captured throughout the supply chain and processed by data alignment module 24 to generate market data 44E that provides the basis for comprehensive market models and reports. For example, market analysis module 26 may use the aligned data to generate a market penetration report that traces part flows from suppliers 6 through distributors 8 to customers 10. Market analysis module 26 may generate the report to identify sales volumes and accounts at each stage of the supply chain, and based on any of a variety of filters, such as geography, customer solutions, market segments, sales volume, and the like. Moreover, market analysis module 26 may generate the report for a particular enterprise within the supply chain (e.g., a particular supplier 6) and in a format consistent with the part definitions of the enterprise.

As illustrated in FIG. 1, supply chain management system 4 provides a centralized system for management of multiple supply chains formed by associations of diverse suppliers 6, distributors 8, and customers 10. In one embodiment, supply chain management system 4 operates within an application service provider (ASP) computing environment in which connectivity module 22 electronically communicates with multiple remote supplier data systems 17, distributor data system 18, and customer data systems 19, which each may be associated with one or more supply chains managed by supply chain management system 4.

Configuration manager 32 presents an interface via user interface modules 29 allowing system administrators for the various enterprises (e.g., suppliers 6, distributors 8 and customers 10) to configure supply chain management system 4. A system administrator may, for example, manage accounts for authorized users 15 including setting access privileges, and defining a number of corporate and user preferences. Configuration manager 32 allows system administrators for each enterprise to define individual access rights for controlling the functionality of application software modules 23 on a per-user basis. In this manner, not all users 15 associated with a given enterprise can access all of application software modules 23.

In addition, a system administrator for each enterprise may access supply chain management system 4 and provide configuration data 44D to tailor the supply chain management system for the particular needs of the enterprise. For example, based on the configuration data 44D supplied be each enterprise, configuration manager 32 selectively activates application software modules 23 operating within supply chain management system 4 for that enterprise. Consequently, each enterprise may make use of all or only portions of the functionality offered by application software modules 23 of supply chain management system 4. In this manner, control and integration of supply chain management system 4 with the various enterprises can be configured for each stage of each supply chain managed by the system.

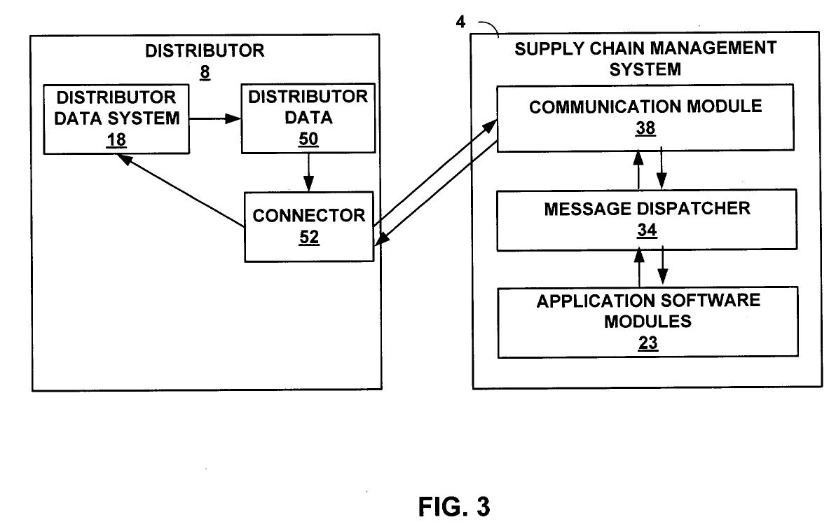

FIG. 3 is a block diagram that illustrates data communication between supply chain management system 4 and an exemplary distributor data system 18. Although illustrated with respect to a distributor data system 18, the techniques can be used for communication between supply chain management system 4 and any enterprise data system within the supply chain, e.g., supplier data systems 17, distributor data systems 18, and customer data systems 19.

In the illustrated example, a distributor 8 includes an internal distributor data system 18, which exports distributor data 50. Distributor data system 18 may export distributor data 50 periodically (e.g., nightly or weekly) or in response to specific triggers or events (e.g., shipment of product 16). Connector 52 executes within the computing environment of distributor 8, and monitors for new exported distributor data 50. Connector 52 may, for example, comprise a software service or other module that periodically checks a shared network folder or other storage location for the presence of newly exported distributor data 50. Upon detecting distributor data 50, connector 52 communicates the data to connectivity module 22 of supply chain management system 4 (e.g., via network 9 using one or more communication protocols). Message dispatcher 34 analyzes the incoming data, and dispatches one or more messages to application software modules 23 to process the data.

Connector 52 receives electronic communications from supply chain management system 4, and forwards the communications to distributor data system 18. Connector 52 may, for example, receive communications from supply chain management system 4 via network 9 using one or more network protocols, and may process the communications into a format that may be processed by distributor data system 18.

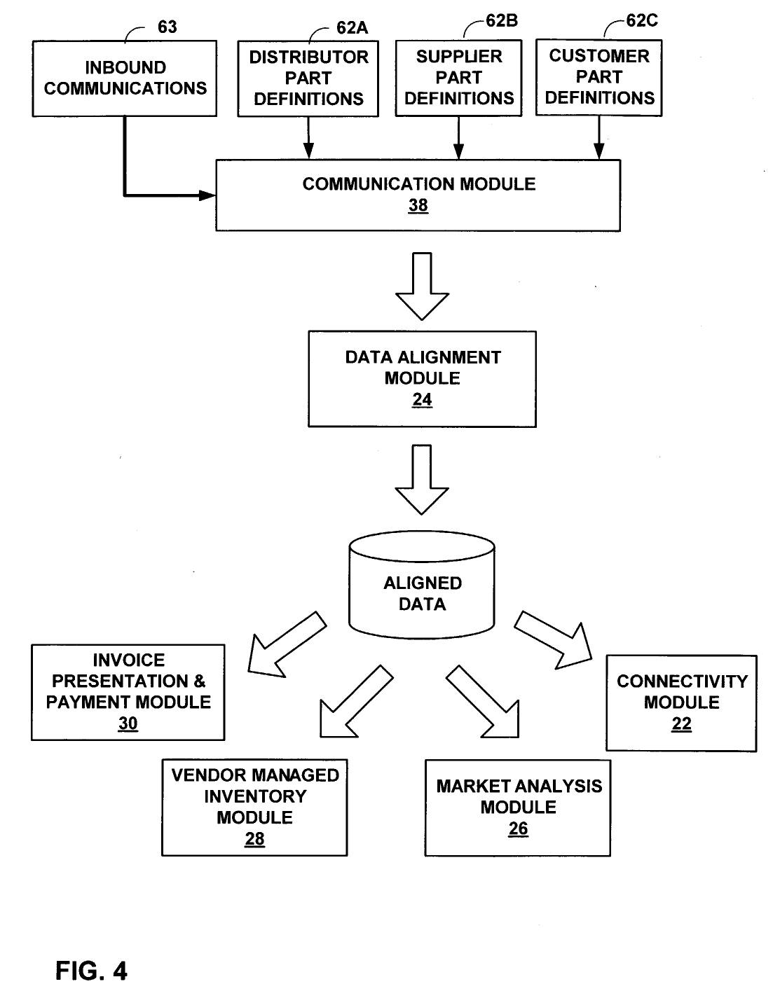

FIG. 4 is a block diagram illustrating the flow of data through supply chain management system 4 and, in particular, from communication module 38 to the various application software modules 23. As described above, supply chain management system 4 receives part definitions for each enterprise within the supply chain. Specifically, communication module 38 receives distributor part definitions 62A from distributors 8, supplier part definitions 62B from suppliers 6, and customer part definitions 62C from customers 10. Moreover, communication module 38 may receive the part definitions periodically (e.g., nightly or weekly) or when the definitions change for a particular enterprise.

Data alignment module 24 processes the part definitions 62 received by communication module 38, and generates a mapping between the part definitions of the enterprises within the supply chain. Based on this mapping, data alignment module 24 provides for the automated translation of all inbound communications 63 received from enterprises of the supply chain. Data alignment module 24 may translate all inbound communications 63 to a common, internal format based on the product definitions 62. Once translated, the aligned data is used by connectivity module 22, VMI module 28, EIPP module 30 and market analysis module 26 to provide management and control over all stages of the supply chain.

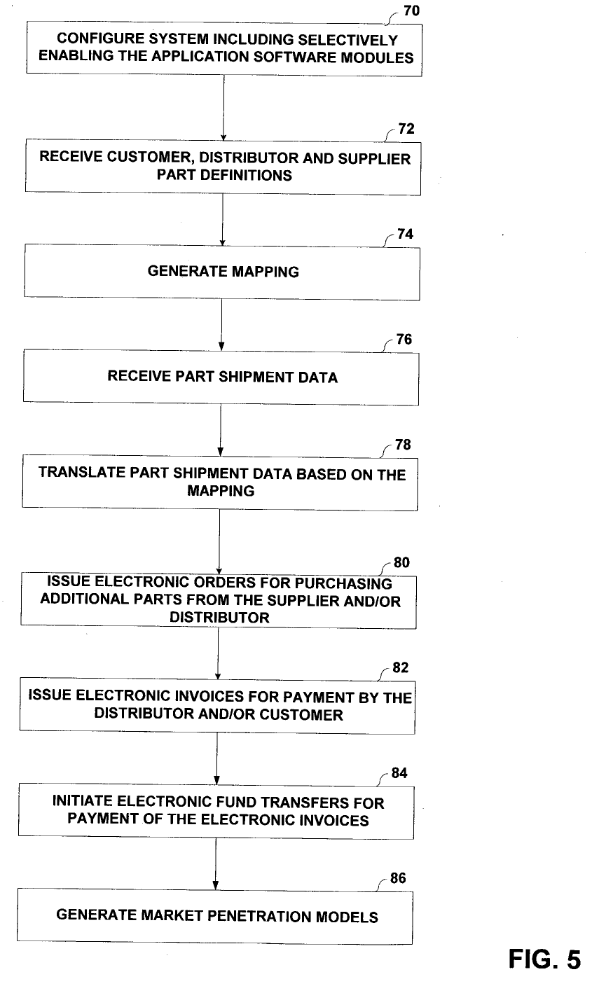

FIG. 5 is a flow chart illustrating the operation of supply chain management system 4 for integrated management and control of all stages of a supply chain. Initially, an authorized user, such as a system administrator, interacts with configuration manager 32 to configure supply chain management system 4 including setting up user accounts, defining preferences, access rights, and selectively enabling one or more of application software modules 23 (70).

Next, supply chain management system 4 receives part definitions from the various enterprises within the supply chain (72). Data alignment module 24 processes the part definitions 62 received by communication module 38, and generates a mapping between the part definitions (74).

Data alignment module 24 provides for the automated translation of all inbound communications received from enterprises of the supply chain. For example, supply chain management system 4 receives part shipment data from distributor data systems 18 that describe parts shipped within the supply chain (e.g., from suppliers 6 to distributor 8, from distributors 8 to customers 10, and the like (76)). Supply chain management system 4 may receive the part definitions and part shipment data periodically (e.g., nightly or weekly, or asynchronously) when parts are shipped or the definitions changed. Data alignment module 24 translates the part shipment data based on the mapping (78).

VMI module 28 analyzes the translated part shipment data and generates forecast data indicating predicted demand values for the parts at various stages of the supply chain. Based on the predicted demand, VMI module 28 may generate electronic orders for purchasing additional parts from the respective suppliers 6 or distributors 8 (80). VMI module 28 may communicate the electronic orders to the appropriate supplier data systems 17 for automated purchase of the additional parts from the supplier for the distributor, or present the electronic orders via user interface modules 29 and web servers 20 for approval by the appropriate users.

In response to product orders within the supply chain, either by VMI module 28 or by the enterprises, EIPP module 30 generate electronic invoices for payment by the appropriate payors, e.g., distributors 8 or customers 10 to which product 16 is being shipped (82). EIPP module 30 makes use of the aligned data and mapping scheme maintained by supply chain management system 4 to generate each of the electronic invoices in a format consistent with the part definitions received from the payor. EIPP module 30 may communicate the electronic invoices to the data system of the payors, or may present the electronic invoices via user interface modules 29 and web servers 20 for approval by authorized users 15 associated with the payors. Upon receiving an approval, EIPP module 30 initiates an electronic transaction to transfer funds from a bank account of the payor to a bank account of the payee for payment of the electronic invoices (84). EIPP module 30 interacts with the data systems 17, 18, 19 within the supply chain to update accounts payables and accounts receivables of the enterprises based on the status of the invoices.

This process continues as products flow through the supply chain. In particular, at any point, new product definitions may be received, causing data alignment module 24 to update the product mapping maintained by supply chain management system 4. Moreover, VMI module 28 and EIPP module 30 continue to interact to manage inventory levels and control the purchase and payment for products 16. During this process, market analysis module 26 utilizes the aligned data captured throughout the supply chain to generate comprehensive market models and reports (86).

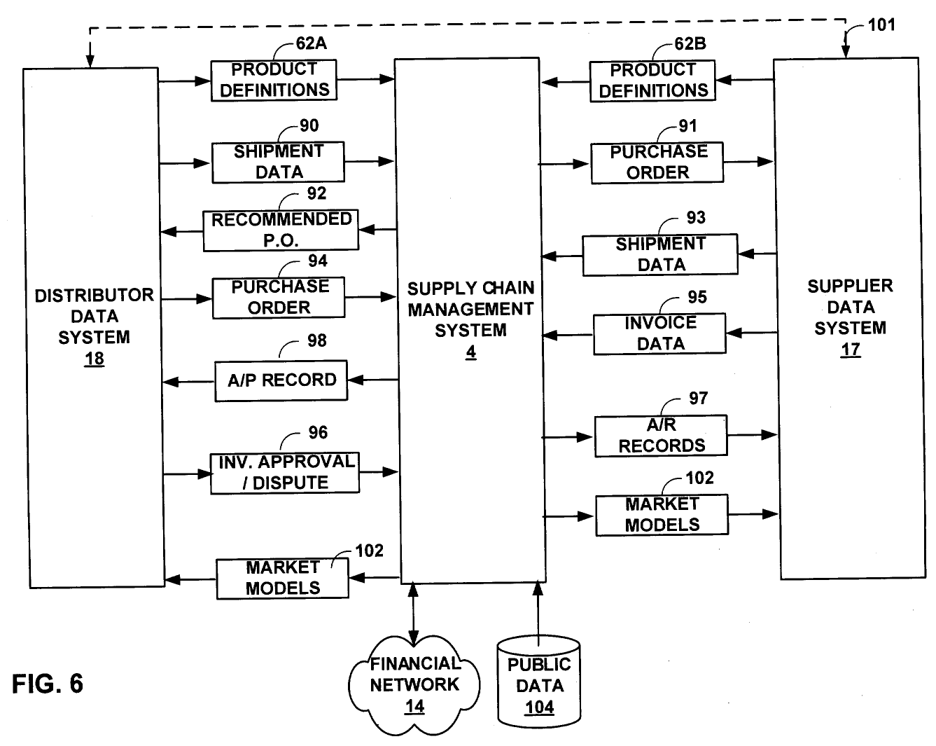

FIG. 6 is a block diagram that generally illustrates the flow of electronic communication between supply chain management system 4 and enterprises within the supply chain. For exemplary purposes, FIG. 6 illustrates the flow of electronic communication between supply chain management system 4, a supplier data system 17 and a distributor data system 18.

As described above, supply chain management system 4 receives product definitions 62 from supplier data system 17 and distributor data systems 18. In addition, supply chain management system 4 receives shipment data 90 from distributor data system 18 that describes products 16 shipped to customers 10. Based on shipment data 90, supply chain management system 4 may automatically issue purchase orders 91 to supplier data system 17 for purchase of additional products, or may issue recommended purchase orders 92 to distributor data system 18. In response, distributor data system 18 may indicate the approval of the recommended purchase orders 92, or act as a source for electronic purchase orders 94.

In response to the shipped purchase orders, supply chain management system 4 receives invoice data 95 from supplier data system 17, and communicates electronic invoices in the form of accounts payable (A/P) records 98 to distributor data system 18. Supply chain management system 4 receives an electronic communication 96 indicating approval or dispute of the invoices. For approved invoices, supply chain management system 4 initiates a transaction between payor and payee accounts via interaction with financial network 14. Supply chain management system 4 updates the accounts/receivable (A/R) of the payee by issuing A/R records 97 to supplier data system 17.

In addition, supply chain management system 4 issues market models 102 to enterprises within the supply chain, e.g., supplier data system 17, for review. During this process, supply chain management system 4 may incorporate publicly available corporate information regarding enterprises within the supply chain, including customers 10. Supply chain management system 4 may, for example, utilize data captured from various stages within the supply chain with public data 104 (e.g., Dunn & Bradstreet (D&B) reports and Standard Industrial Classifications (SIC) codes) to identify additional sales opportunities. In some embodiments, distributor data system 18 and supplier data system 17 may utilize direct communications 101 to send at least some of these electronic messages, thereby bypassing supply chain management system 4.

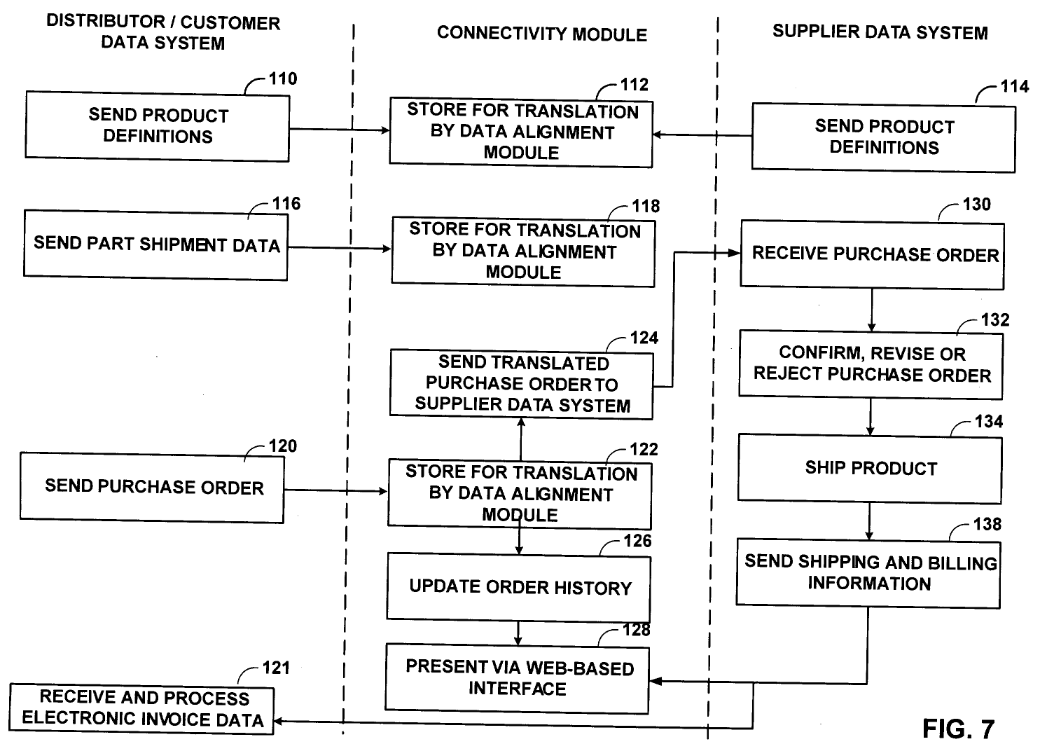

FIG. 7 is a flowchart illustrating example operation of connectivity module 22 in further detail. For purposes of example, FIG. 7 illustrates operation of connectivity module 22 while interacting with data systems of a supplier 6 that ships product 16 to a distributor 8. Supply chain management system 4 operates in similar manner while interacting with other producers and consumers of the supply chain (e.g., distributors 8 that sell product 16 to customers 10).

Connectivity module 22 receives product definitions from a supplier data system 17 and a distributor data system 18 (110, 114), and stores the product definitions within data stores 44 maintained by database servers 42 for processing by data alignment module 24 (112). Similarly, connectivity module 22 receives and stores part shipment data (118).

Upon receiving purchase orders from the distributor data system 18 (120), connectivity module 22 stores the purchase orders for translation by data alignment module 24 (122), and updates an order history for the distributor 8 (126). Next, connectivity module 22 issues translated purchase orders to the supplier data system 17 (124). Upon receipt (130), supplier data system 17 allows the supplier 6 to confirm, revise, or reject the purchase orders (132). If confirmed, supplier 6 ships product to the ordering enterprise (134), and electronically communicates shipping and billing information (138) to connectivity module 22 for presentment via user interface modules 29 (128) or for translation for direct communication to distributor data system 18 (121).

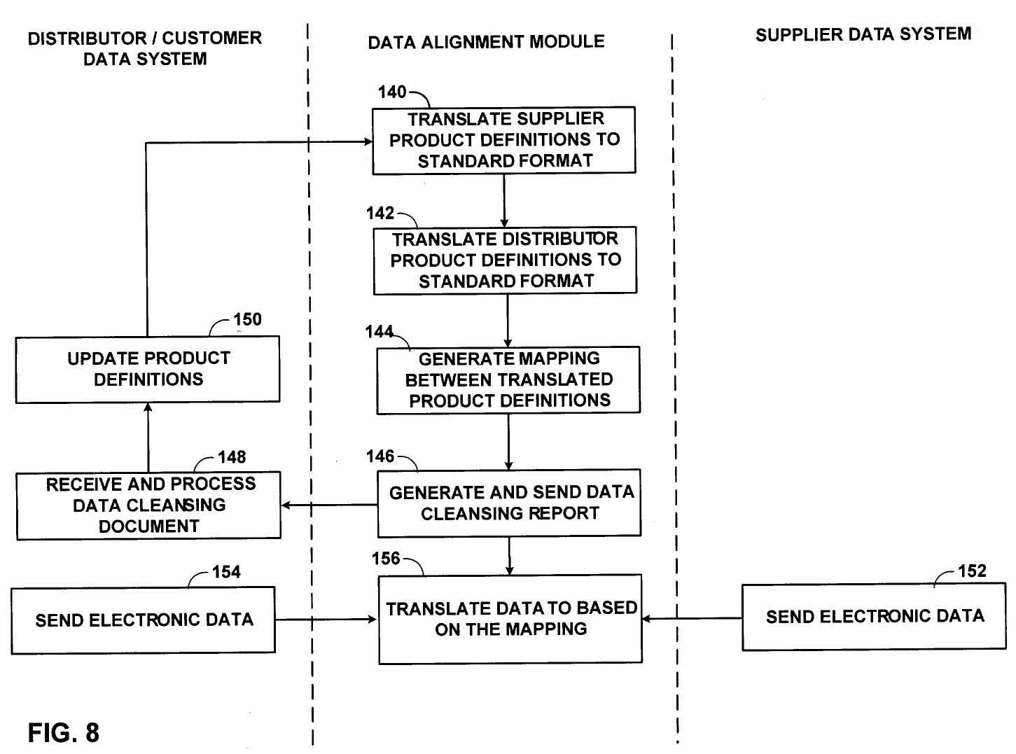

FIG. 8 is a flowchart illustrating example operation of data alignment module 24 in further detail. Initially, data alignment module 24 accesses data stores 44 of database servers 42 (FIG. 2) to retrieve and translate product definitions received from the data systems of the enterprises (140, 142). Once translated, data alignment module 24 generates a mapping for translating subsequently received data in accordance with the product definitions (144). During this process, data alignment module 24 may generate and send one or more electronic “cleansing” reports to the data systems (e.g., distributor data system 18) that indicate any discrepancies between the various part definitions (146). For example, the cleansing reports may indicate missing information within a defined schema for the part definitions. Distributor 8 processes the cleansing report (148), and updates its product definitions (150).

Data alignment module 24 processes all inbound communication (152, 154) in accordance with the mapping to provide automated translation of electronic data received from enterprises of the supply chain (156). Data alignment module 24 stores the translated data in data stores 42 for use by other application software modules 23.

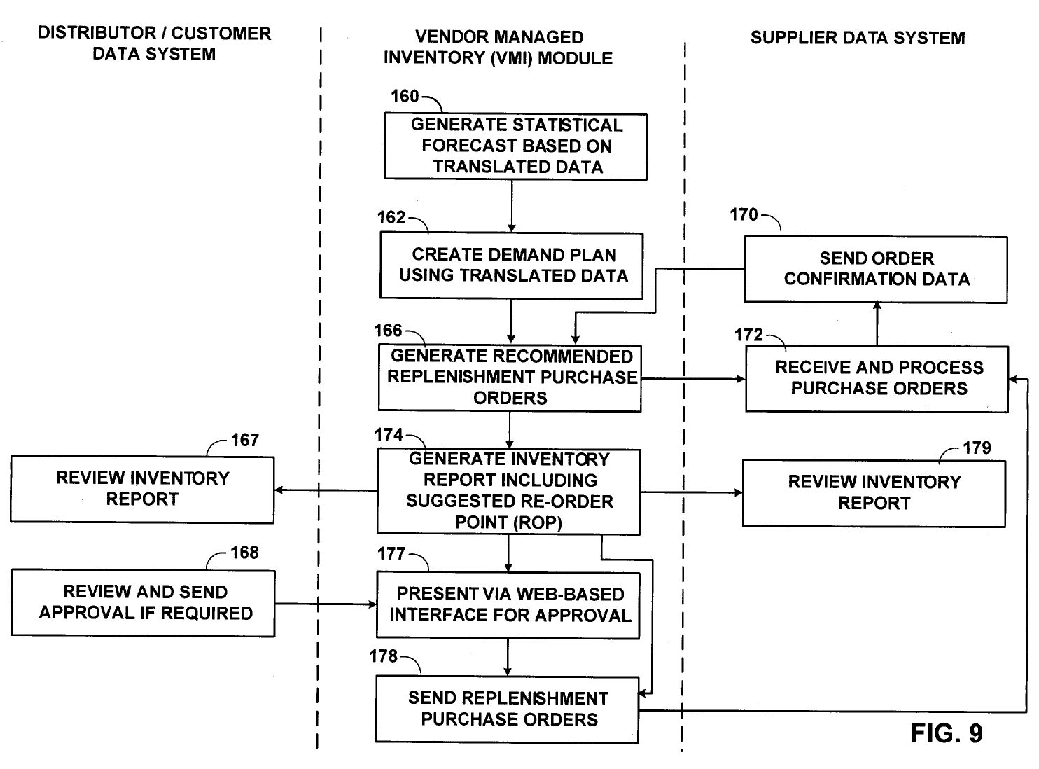

FIG. 9 is a flowchart illustrating example operation of VMI module 28 in further detail. Initially, VMI module 28 analyzes data from the various enterprises within the supply chain to generate forecast data indicating predicted demand levels for the enterprises (160).

Based on the analysis, VMI module 28 generates a demand plan (e.g., a Demand Solutions Requirements Plan (DSRP) or an Inventory Plan) which can be useful determining an optimal level of inventory needed to support the various enterprises of the supply chain (162). These plans may allow VMI module 28 or the enterprises to track the volatility and relative importance of each part used within the supply chain. Moreover, these plans can be used to evaluate the projected demand for each of the parts against its current inventory, with allowance for transit quantities and open customer orders. In other words, VMI module 28 is forward-looking, and can perform this evaluation for upcoming intervals, such as a number of days, weeks, fiscal quarters, and the like. Based on the projected demand and inventory levels, VMI module 28 determines recommended purchase orders over the future period (166), as well as suggested re-order points (ROPs) (174). Supplier data system 17 receives and processes the purchase orders (172), and sends confirmation data to VMI module 28 to confirm the orders (170). During this process, VMI module 28 utilize the aligned data and the part definition mapping to generate reports and recommended repurchase orders for review by the supplier, distributor, or both (167, 179).

VMI module 28 may present the electronic orders via user interface modules 29 and web servers 20 for approval by the appropriate users (177, 168). Once approved, or immediately if no approval is needed, VMI module 28 communicates the electronic orders to supplier data system 17 to automatically purchase the additional parts from the supplier for the distributor (178).

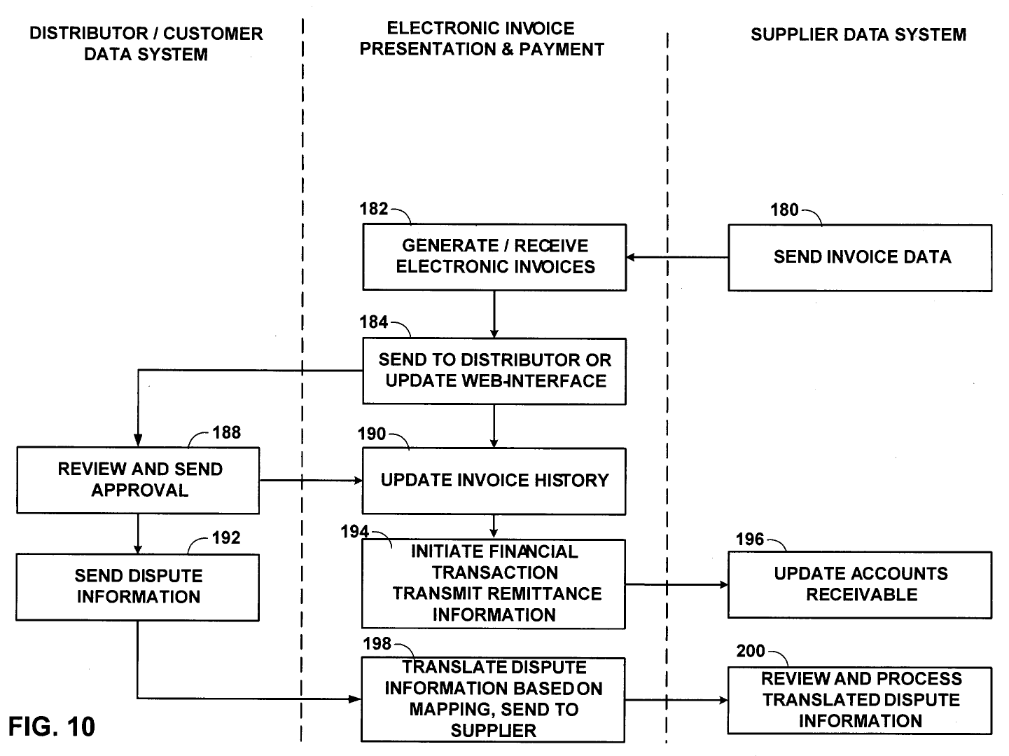

FIG. 10 is a flowchart illustrating example operation of EIPP module 30 in further detail. In general, EIPP module 30 receives and processes invoice data either for invoices automatically created by VMI module 28, or invoices generated by supplier data system 17 (180). In addition, EIPP module 30 receives and processes confirmation data from supplier data systems 17 indicating an order has been processed (181).

EIPP module 30 handles presentation of the electronic invoices to distributor 8, either directly or via user interface software modules 29 and web servers 20 (184). EIPP module 30 may require electronic approval by distributor 8 (188), and updates invoice history to reflect the current status of the invoices (190). For approved invoices, EIPP module 30 initiates a transaction between payor and payee accounts via interaction with financial network 14, and transmits remittance information for updating receivables of supplier data system 17 (194, 196). Alternatively, distributor data system 18 may transmit dispute information disputing one or more invoices, which EIPP module 30 translates part definitions in accordance with the mapping and forwards them to supplier data system 17 for review and processing (192, 198, 200).

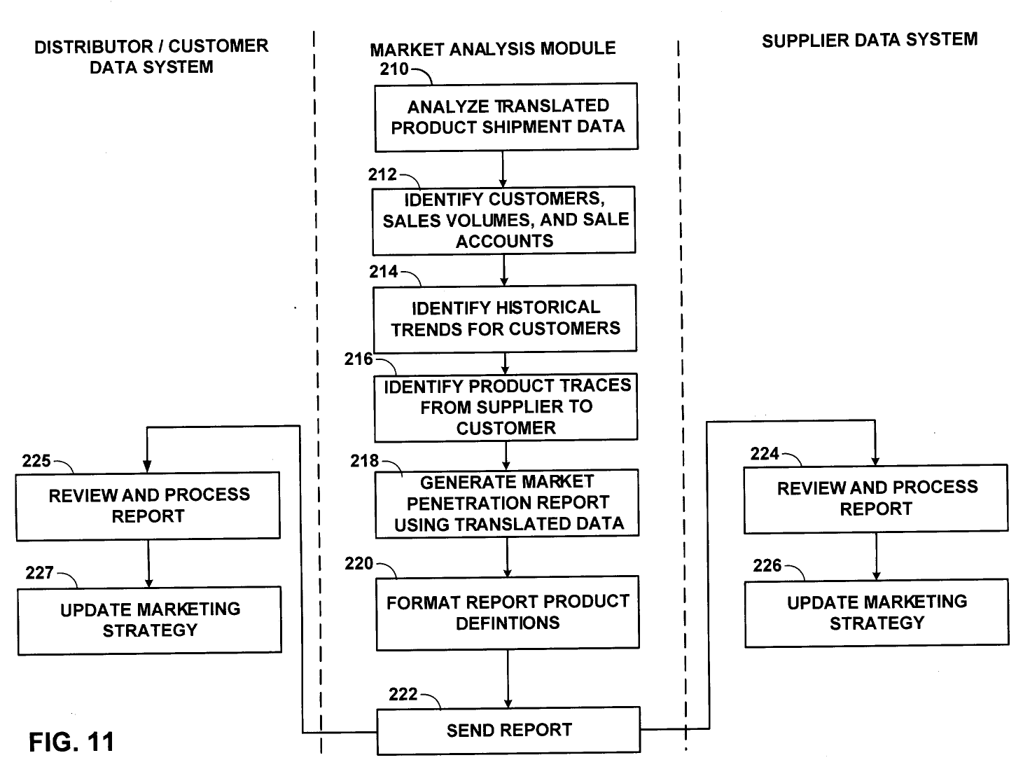

FIG. 11 is a flowchart illustrating example operation of market analysis module 26 in further detail. Market analysis module 26 analyzes the aligned data captured throughout the supply chain (e.g., product shipment data that describes products shipped from distributors 8 to customers 10 (210)). During the analysis, market analysis module 26 may identify sales opportunities based on existing customers, sales volumes, sales accounts, historical trends, product flows, and other market data for the supply chain (212, 214, 216). Based on the analysis, market analysis module 26 generates complex marketing reports tailored for each enterprise within the supply chain, and in a format consistent with the part definitions of the enterprise (218, 220). Market analysis module 26 transmits the reports to the respective enterprises for review (222), possibly resulting in new marketing strategies (224-227).

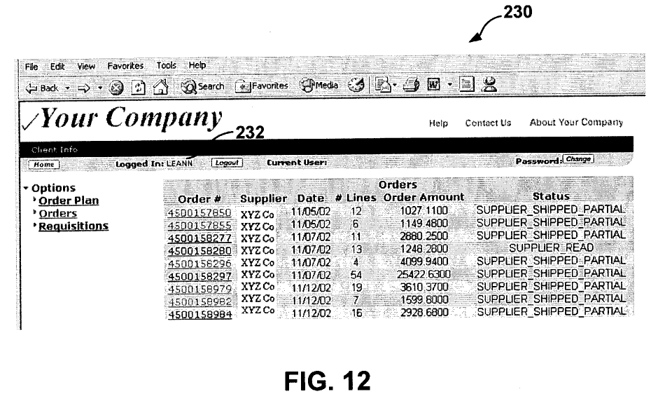

FIG. 12 illustrates an example web-based user interface 230 presented by connectivity module 22 via user interface modules 29 and web servers 20. As illustrated, interface 230 provides an authorized user 232 a number of options, including viewing inventory order plans and pending requisitions, as provided by VMI module 28, as well as pending purchase orders.

Upon electing to view pending orders received by the company associated with user 232, interface 230 presents a list of orders sorted by order number. Interface 230 presents a summary of each order, including order number, the supplier, the order date, a number of lines (items) for the order, an order amount, and a status for the order.

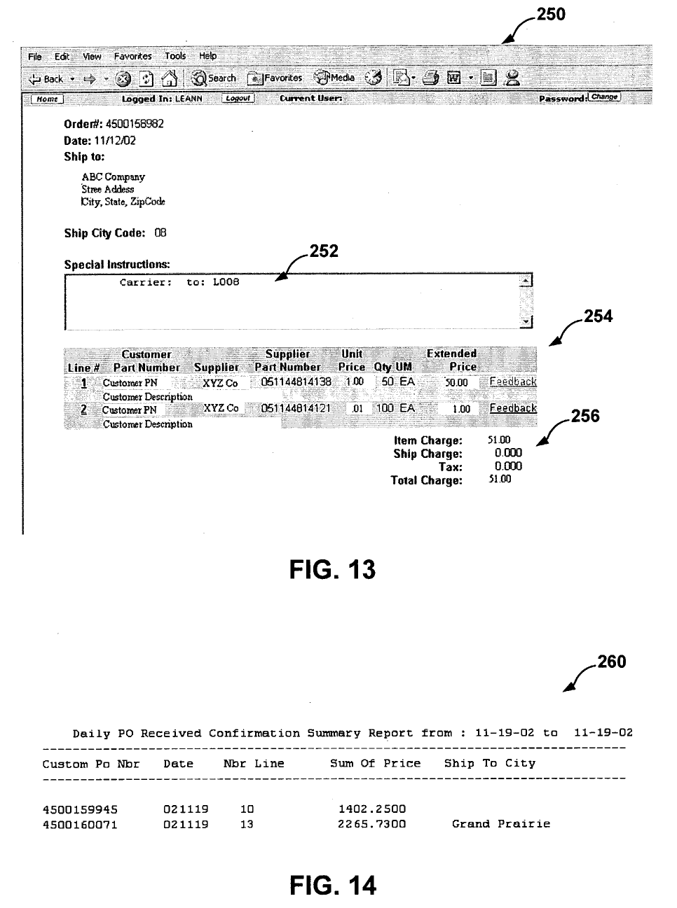

FIG. 13 illustrates an example interface 250 presented by connectivity module 22 when user 232 selects an individual order. In particular, interface 250 presents detailed information for the selected order, including any special shipping instructions 252, the individual items 254 that constitute the order, and charges 256 for the order. For each item 254, interface 250 lists a customer part number, a supplier, a supplier part number, a unit price, a quantity, a unit of measure, and an extended price. Connectivity module 22 generates this information based on the part definitions provided by the enterprises.

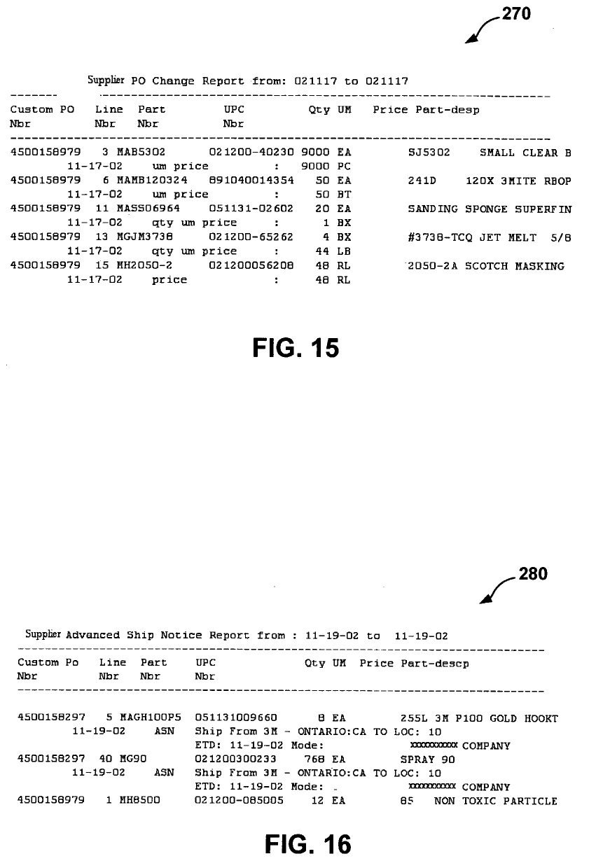

FIG. 14 illustrates an example purchase order confirmation 260 provided by connectivity module 22 upon receiving purchase orders from an enterprise. FIG. 15 illustrates a purchase order change detail 270 that lists any modifications to the purchase order based on the product definitions provided by the supplier. In particular, connectivity module 22 may process the purchase order based on the mappings provided by the supplier to complete or correct the order. For example, connectivity module may generate change detail 270 to include part descriptions, units of measure, supplier part numbers, and other information not provided by the purchase order. FIG. 16 illustrates an example advance ship notice 280 generated by connectivity module 22 and communicated to the purchaser upon receiving shipment data from the supplier.

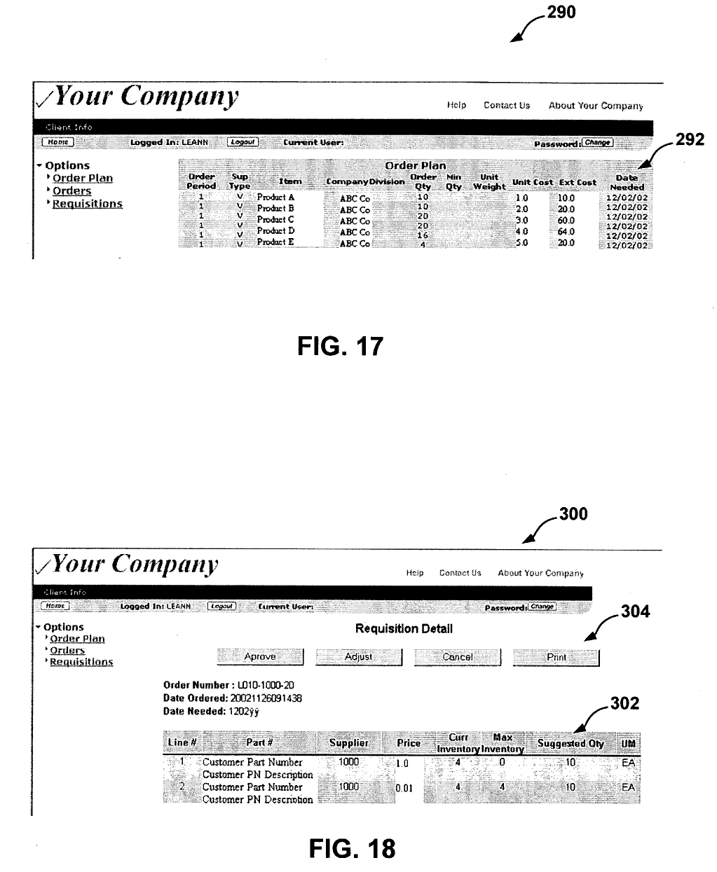

FIG. 17 illustrates an example interface 290 provided by VMI module 28 when the user elects to view an order plan for the company associated with the user. As illustrated, interface 290 lists a number of orders 292 for a future order period. For each order 292, interface 290 lists a supplier type (e.g., vendor), the item to be ordered, the purchasing company or division, a quantity to be ordered, a unit cost, an extended or total cost, and a date by which the items will be needed.

FIG. 18 illustrates an example interface 300 provided by VMI module 28 when the user elects to view pending requisitions, i.e., pending requisition orders by the company for purchasing additional items from one or more suppliers. In particular, interface 300 presents a requisition order number, an order date, a date by which the items are needed, and the individual items 302 that constitute the requisition. Interface 300 provides input areas 304 by which the user can approve, adjust, cancel or print the requisition.

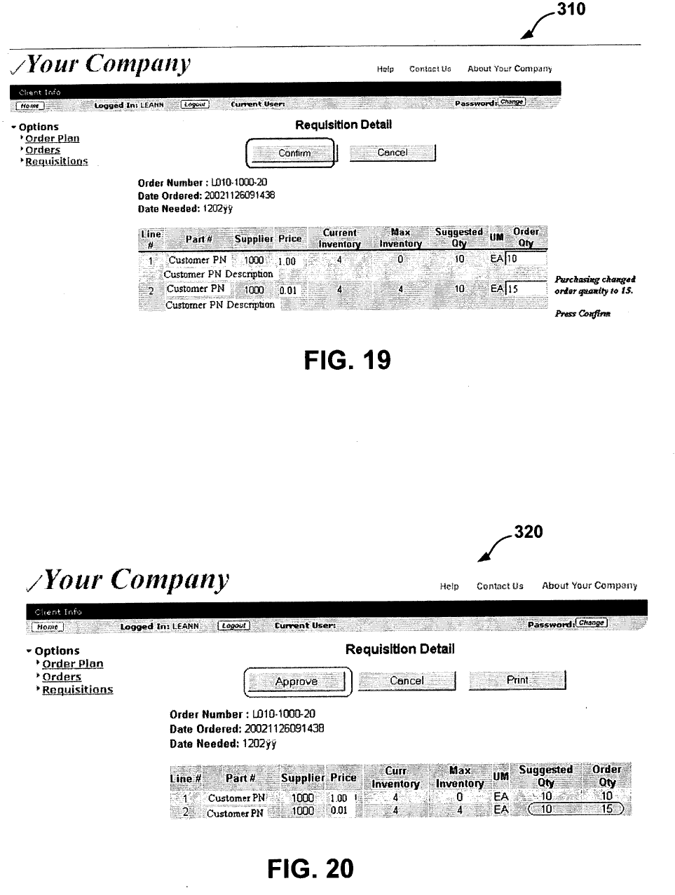

FIG. 19 illustrates an example interface 310 provided by VMI module 28 when the user elects to adjust a requisition. In particular, the user has changed a quantity for the second item to fifteen. FIG. 20 illustrates an interface 320 presented by VMI module 28 when the user approves the requisition after changing the quantity.

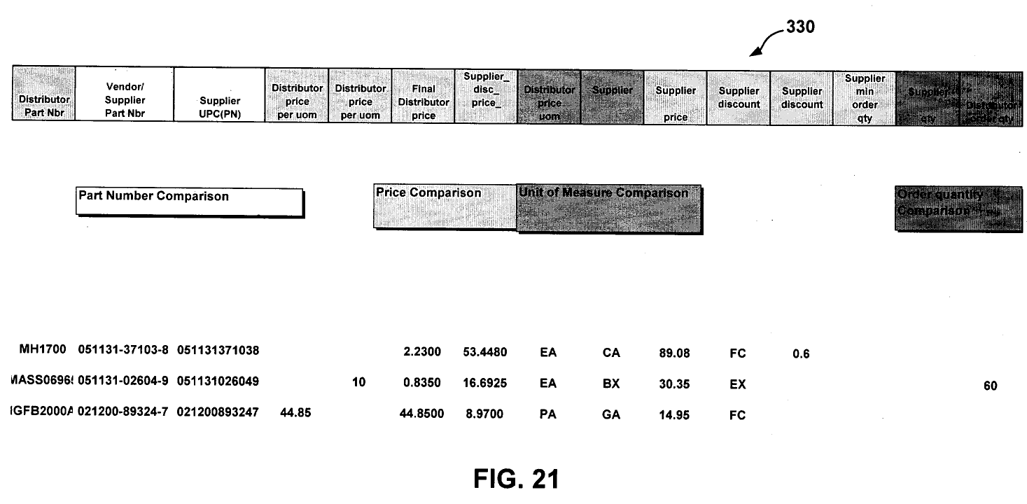

FIG. 21 illustrates an exemplary reconciliation report 330 produced by data alignment module 24 that identifies potential inconsistencies between part definitions of a product and a consumer of a part, e.g., a supplier and a distributor or a distributor and a customer. In particular, report 330 is presented in spreadsheet form in which each column lists a definition provided by either the supplier or the distributor. During the mapping processes, data alignment module 24 validates the part definitions. For example, data alignment module 24 compares the part numbers, prices, minimum quantities, units of measure, and other fields provided by the enterprises.

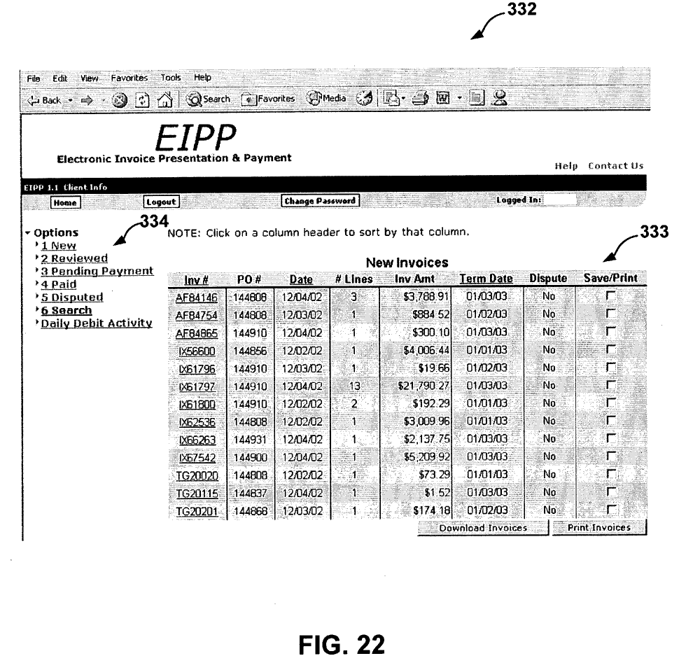

FIG. 22 illustrates an example interface 332 presented by EIPP module 30 to an authorized consumer within the supply chain (i.e., a payee for one or more invoices associated with the supply chain). Interface 332 presents a menu 334 allowing a user to view (1) new electronic invoices that supply chain management system 4 has recently received, (2) invoices that have been already been reviewed by the payor, (3) invoices that approved by the payor and for which payment is pending, (4) invoices that have been paid, and (5) disputed invoices. In addition, menu 334 allows user may search for invoices, and view electronic payment activities on a daily basis.

When directed, interface 332 lists invoices within a window 333. FIG. 22 illustrates interface window 333 listing newly received invoices. For each invoice, interface 332 lists an invoice number, a purchase order number, a corresponding date of the invoice, a number of items (lines) on the invoice, an invoice amount, a payment term, and a dispute status.

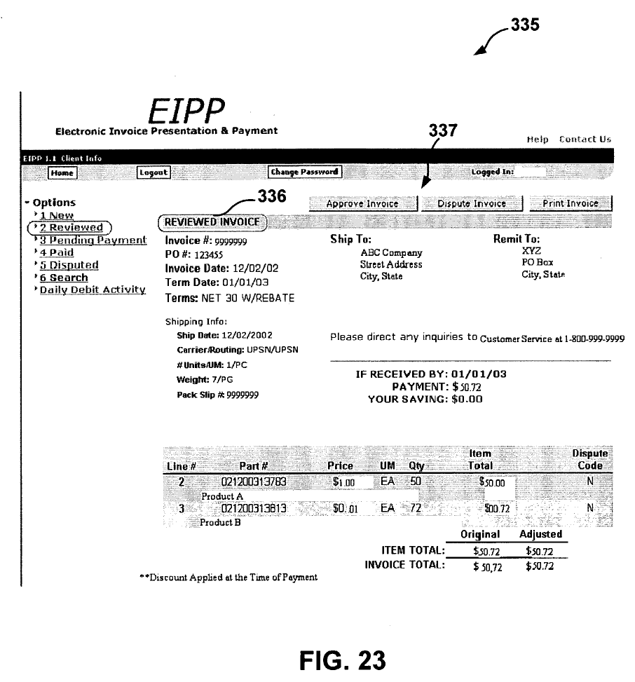

FIG. 23 illustrates an example interface 335 presented by EIPP module 30 when a user elects to view the details of an invoice by selecting the invoice number. As illustrated, once viewed, a status 336 of the invoice changes to REVIEWED, and interface 335 displays the details of the invoice, including the particular line items on the invoice. Interface 335 includes input mechanisms 337 to allow the user to approve or dispute the invoice.

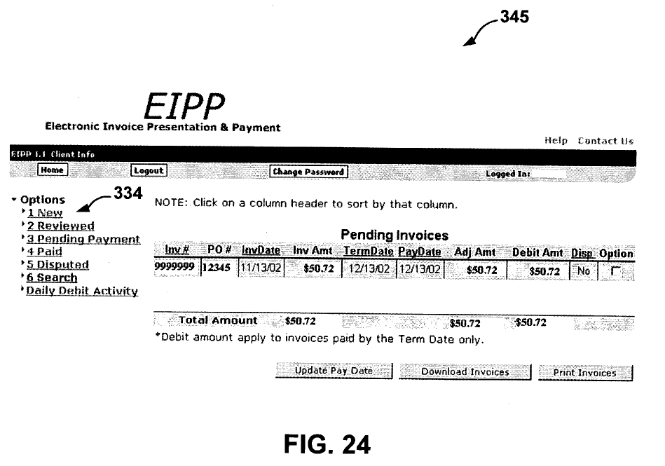

Once approved, the status of the invoice changes to PENDING, and may be viewed under the Pending Payment option of menu 334. FIG. 24 illustrates an example interface 345 when the user elects to view the pending invoices (i.e., the invoices that have been reviewed and approved for payment).

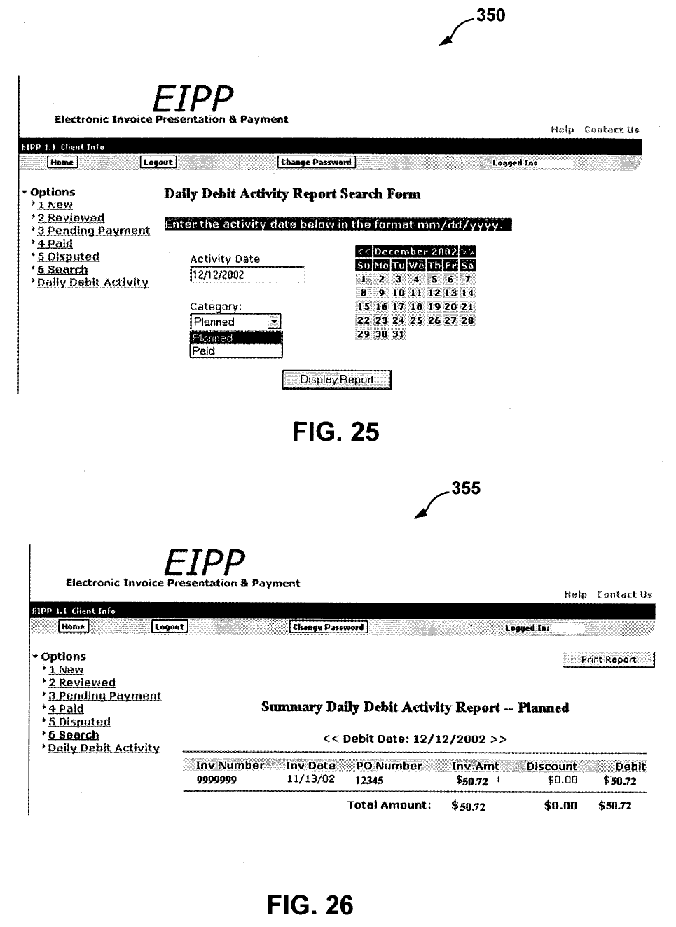

FIGS. 25 and 26 illustrate an example interface 350 presented by EIPP module 30 when the user elects to review the electronic fund transfer (EFT) activity for supply chain management system 4. As illustrated in FIG. 25, the user may select an activity date, and may elect to review planned or completed (paid) transfers. FIG. 26 illustrates an interface 355 presented by EIPP module 30 to display an example pending EFT transaction for a selected date.

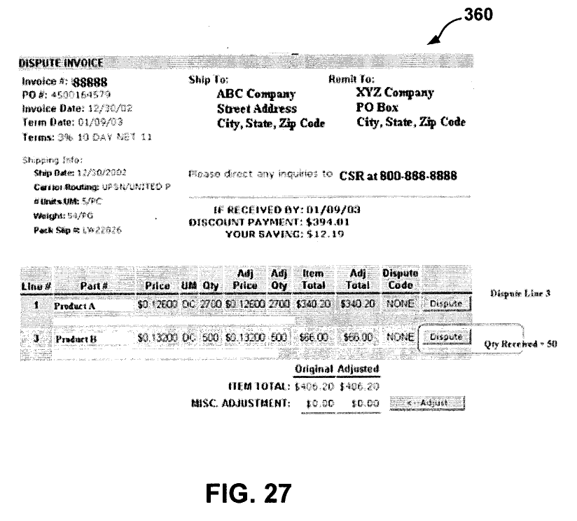

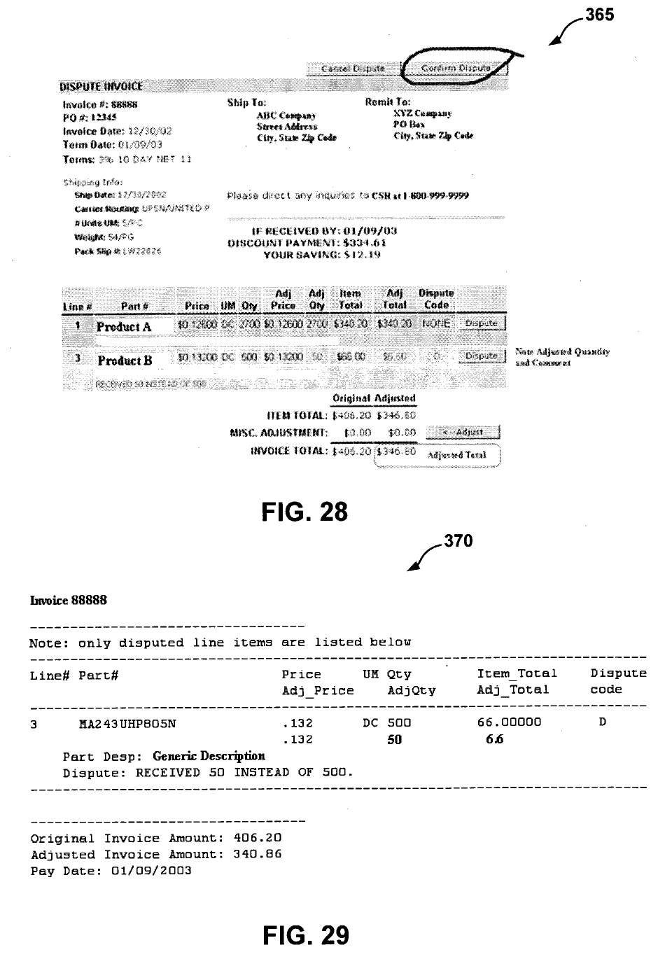

FIG. 27 illustrates an example interface 360 presented by EIPP module when the user elects to dispute an invoice. In particular, interface 360 allows the user to dispute individual line items associated with an invoices. FIG. 28 illustrates an interface 365 that allows a user to correct or otherwise modify a quantity associated with an invoice, automatically recalculate a total due on the invoice, and confirm changes to the disputed invoice. FIG. 29 illustrates an example electronic report 370 that EIPP module 30 issues to the payee (e.g., via electronic mail) when an invoice is disputed by the payor.

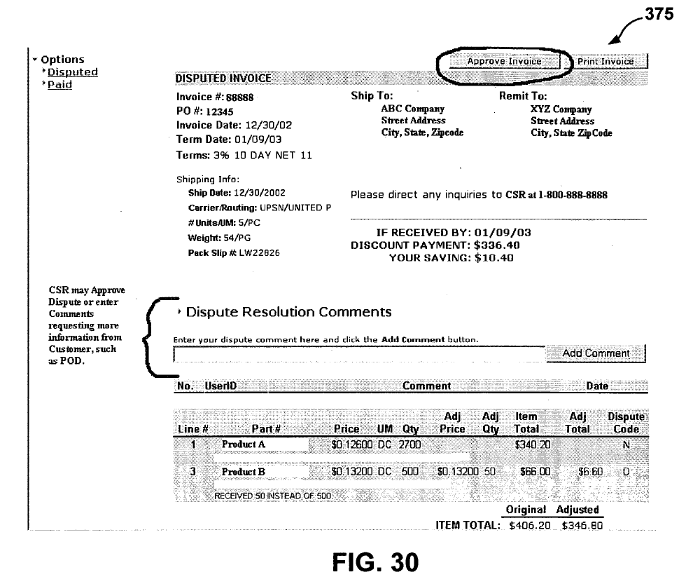

FIG. 30 illustrates an example interface 375 presented by EIPP module 30 to the payee. As illustrated, interface 375 presents the disputed invoice to the payee, and allows the payee to accept the adjusted invoice, or add dispute resolution comments. EIPP module 30 may repeat this process, and provide a forum for payors and payee within a supply chain to easily communicate regarding the details of invoices until the dispute is resolved. At this point, EIPP module 30 automatically changes the status of the invoice to PENDING, and initiates and EFT to pay the invoice.

Various implementations and embodiments of the invention have been described. Nevertheless, it is understood that various modifications can be made without departing from the invention. Accordingly, these and other embodiments are within the scope of the following claims.

1. A system comprising:
a connectivity module that electronically communicates with a distributor data system and a supplier data system, wherein the connectivity module receives from the distributor data system part shipment data for parts shipped from a distributor to customers;
a vendor managed inventory (VMI) module that generates electronic orders for the distributor to purchase additional parts from a supplier based on the part shipment data; and
a market analysis module that generates a market penetration model for the supplier based on the part shipment data received from the distributor data system.

2. The system of claim 1, wherein the market analysis module generates the market penetration model to trace part flows from the supplier to customers of the distributor.

3. The system of claim 1, wherein the part shipment data includes point of sale information that indicates respective distributor sales accounts for the shipments, and the market analysis module generates the market penetration model to identify sales volumes of the parts for each sales account of the distributor.

4. The system of claim 1, further comprising a data alignment module that maintains a mapping between distributor part definitions and supplier part definitions, wherein the market analysis module generates the market penetration model in a format consistent with the supplier part definitions based on the mapping.

5. The system of claim 4, wherein the data alignment module issues a report to at least one of the distributor and the supplier indicating at least one discrepancy between the distributor part definitions and the supplier part definitions.

6. The system of claim 4, wherein the connectivity module electronically receives the distributor part definitions from the distributor data system, and the supplier part definitions from the supplier data system.

7. The system of claim 4, wherein the distributor part definitions include at least one of a distributor part number, a supplier part number, a unit of measure (UOM), a price per UOM, a price multiplier, a rounding value, and a lead time for receiving the part from the supplier.

8. The system of claim 4, wherein the supplier part definitions include at least one of a supplier part number, a unit of measure (UOM), a discount code, a discount amount, a case quantity, a price, a part type, and a lead time for shipping the part.

9. The system of claim 4, wherein the VMI module generates the electronic orders in a format consistent with the supplier part definitions based on the mapping maintained by the data alignment module.

10. The system of claim 1, wherein the VMI module automatically communicates the electronic orders to the supplier data system to purchase the additional parts from the supplier for the distributor.

11. The system of claim 1, wherein the VMI module presents the electronic orders to the distributor for approval.

12. The system of claim 1, wherein the VMI module analyzes the part shipment data and generates forecast data indicating predicted demand values for the parts by the distributor, and generates the electronic order based on the forecast data.

13. The system of claim 1, further comprising an electronic invoice presentation and payment (EIPP) module to generate electronic invoices for payment by the distributor to the supplier in response to the electronic invoices.

14. The system of claim 13, wherein the EIPP module communicates the electronic invoices to the distributor data system.

15. The system of claim 13, wherein the EIPP module presents a web-based interface to the distributor for approval of the electronic invoices.

16. The system of claim 13, wherein the EIPP module initiates electronic fund transfers (EFT) from a bank account of the distributor to a bank account of the supplier for payment of the electronic invoices upon receiving approval from the distributor.

17. The system of claim 4, further comprising an electronic invoice presentation and payment (EIPP) module to generate electronic invoices for payment by the distributor to the supplier in response to the electronic orders, wherein the EIPP module generates the electronic invoices in a format consistent with the distributor part definitions based on the mapping maintained by the data alignment module.

18. The system of claim 17, wherein the EIPP module receives dispute data from the interface indicating a dispute of one or more of the invoices, and presents the dispute data to the supplier via a web-based interface in a format consistent with the supplier part definitions.

19. The system of claim 1, wherein the system operates within an application service provider (ASP) computing environment in which the connectivity module electronically communicates with a one or more remote supplier data systems associated with one or more remote distributor data systems.

20. The system of claim 19, further comprising a configuration manager that presents an interface allowing a system administrator to provide configuration data to selectively configure the system for the different supplier data systems and associated distributor data systems.

21. The system of claim 20, wherein for each of the supplier data systems and the associated distributor data systems the configuration manager selectively enables each of a set of software modules operating within the system

22. The system of claim 21, wherein the software modules include inbound and outbound message queues for exchanging messages between the software modules to control communications with the supplier data systems and the distributor data, and the software modules selectively exchange messages based on the configuration data.

23. The system of claim 21, wherein the software modules dynamically generate web-based interfaces based on the configuration data.

24. The system of claim 21, wherein the configuration manager maintains security data that defines a number of users for the supplier and the distributor authorized to access the system.

25. The system of claim 21, wherein the configuration manager receives security data from the system administrator to control access for users to the set of software modules.

26. The system of claim 21, wherein the set of software modules includes the VMI module, the market analysis module, and the connectivity module.

27. A method comprising:
generating a mapping between distributor part definitions maintained by a distributor data system and supplier part definitions maintained by a supplier data system;
receiving part shipment data from the distributor data system that indicates parts shipped from a distributor to customers, wherein the part shipment data conforms to the set of distributor part definitions; and
generating a market penetration model in a format that conforms to the supplier part definitions based on the mapping.

28. The method of claim 27, wherein generating a market penetration model comprises:
applying the mapping to the part shipment data to generate translated part shipment data that conforms to the supplier part definitions; and
generating a market penetration model based on the translated part shipment data.

29. The method of claim 27, wherein generating the market penetration model comprises generating the market penetration model to trace part flows from the supplier through the distributor to customers.

30. The method of claim 27, wherein the part shipment data includes point of sale information that indicates respective distributor sales accounts for the shipments, and generating the market penetration model comprises generating the market penetration model to identify sales volumes of the parts for each sales account of the distributor.

31. The method of claim 27, further comprising issuing a report to at least one of the distributor and the supplier indicating any discrepancies between the distributor part definitions and the supplier part definitions.

32. The method of claim 27, further comprising electronically receiving the distributor part definitions from the distributor data system and the supplier part definitions from the supplier data system.

33. The method of claim 27, further comprising generating electronic orders for the distributor to purchase additional parts from the supplier based on the part shipment data.

34. The method of claim 33, further comprising generating the electronic orders in a format consistent with the supplier part definitions based on the mapping.

35. The method of claim 33, further comprising automatically communicating the electronic orders to the supplier data system to purchase the additional parts from the supplier on behalf of the distributor.

36. The method of claim 33, further comprising presenting the electronic orders to the distributor for approval.

37. The method of claim 33, further comprising:
analyzing the part shipment data to produce forecast data having predicted demand values for the parts by the distributor; and
generating the electronic order based on the predicted demand values of the forecast data.

38. The method of claim 33, further comprising generating electronic invoices for payment by the distributor to the supplier in response to the electronic orders.

39. The method of claim 38, further comprising generating the electronic invoices in a format consistent with the distributor part definitions based on the mapping.

40. The method of claim 39, wherein generating electronic invoices in a format consistent with the distributor part definitions comprises:
receiving from the supplier data system invoice data in accordance with the supplier part definitions;
applying the mapping to the invoice data to generate translated invoice data in accordance with the distributor part definition; and
generating the electronic invoices based on the translated invoice data.

41. The method of claim 38, further comprising communicating the electronic invoices to the distributor data system for approval by the distributor.

42. The method of claim 38, further comprising presenting a web-based interface to the distributor for approval of the electronic invoices.

43. The method of claim 38, further comprising initiating electronic fund transfers (EFT) from a bank account of the distributor to a bank account of the supplier for payment of one or more of the electronic invoices.

44. The method of claim 38, further comprising:
receiving dispute data from the interface indicating a dispute of one or more of the invoices;
applying the mapping to the dispute data to translate the dispute data to a format that conforms to the supplier part definitions; and
presenting the translated dispute data to the supplier via a web-based interface for resolution.

45. The method of claim 27, further comprising generating the market model with a computing system operating within an application service provider environment that is communicatively coupled to a plurality of remote supplier data systems associated with one or more remote distributor data systems.

46. The method of claim 45, further comprising presenting an interface allowing a system administrator to provide configuration data to selectively configure the computing system for the supplier data systems and the associated distributor data systems.

47. The method of claim 46, further comprising selectively enabling each of a set of software modules operating within the computing system based on the configuration data.

48. The method of claim 47, further comprising selectively exchanging messages between the software modules to control communications with the supplier data systems and the distributor data systems based on the configuration data.

50. The method of claim 47, further comprising dynamically generating web-based interfaces for the software modules based on the configuration data.

51. The method of claim 47, further comprising controlling access to the software modules by a set of users based on the configuration data.

52. The method of claim 47, wherein the set of software modules includes:
a connectivity module that electronically communicates with the distributor data systems and the supplier data systems, and receives distributor part definitions for the distributor data systems and supplier part definitions from the supplier data systems;
a data alignment module that maintains a mapping between distributor part definitions and supplier part definitions for associated distributor data systems and supplier data systems; and
a market analysis module that generates the market penetration models.

53. A system comprising:
a connectivity module that electronically communicates with a customer data system and a service supplier data system, wherein the connectivity module receives data from the customer data system indicating services received from a supplier;
an electronic invoice presentation and payment (EIPP) module to generate electronic invoices for payment by the customer to the supplier for the services; and
a market analysis module that generates a market penetration model for the supplier based on the data received from the customer data system.

54. The system of claim 53, further comprising a data alignment module that maintains a mapping between customer definitions and supplier definitions, wherein the market analysis module generates the market penetration model in a format consistent with the service supplier definitions based on the mapping.

55. The system of claim 54, further comprising a vendor managed inventory (VMI) module that generates electronic orders for the customer to purchase additional services from the supplier based on the data.

56. The system of claim 55, wherein the VMI module generates the electronic orders in a format consistent with the supplier definitions based on the mapping maintained by the data alignment module.

57. The system of claim 54, wherein the VMI module analyzes the data and computes predicted demand values of the services provided by the supplier, and generates the electronic orders based on the demand values.

58. The system of claim 54, wherein the connectivity module receives part shipment data from the customer data system for parts received from the supplier, and the VMI module generates electronic orders for the customer to purchase additional parts from the supplier based on the data.

59. The system of claim 58, wherein the market analysis module generates the market penetration model for the supplier based on the services and parts provides to the customer.
